(19) United States
(12) Patent Application Publication
(10) Pub. No.: US 2008/0032775 A1
(43) Pub. Date: Feb. 7, 2008

(54) GAMING MACHINE AND GAMING METHOD THEREOF

(75) Inventor: Kazumasa YOSHIZAWA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORPORATION, Tokyo (JP)

(21) Appl. No.: 11/780,621

(22) Filed: Jul. 20, 2007

(30) Foreign Application Priority Data
Aug. 7, 2006 (JP) 2006-214900

(51) Int. Cl. G06F 17/00

(52) U.S. Cl. 463/20

(57) ABSTRACT

A gaming environment with the use of polyhedrons is described. Three reels may be variably displayed. Each of reels may be constructed from polyhedrons. Nine polyhedrons may be stopped and displayed with 3×3 matrix on a display. If a predetermined symbol is displayed on any of front surfaces of the polyhedrons, only polyhedron having the predetermined symbol may be rotated. If a combination of the symbols displayed on front surfaces of the polyhedrons located at middle row of the 3×3 matrix is any winning combination, an award will be provided to a user.

### CROSS-REFERENCE TO RELATED APPLICATIONS

This application is based upon and claims a priority from the prior Japanese Patent Application No. 2006-214900 filed on Aug. 7, 2006, the entire contents of which are incorporated herein by reference.

### BACKGROUND

1. Field

One or more aspects of the present invention relate to a gaming machine and gaming method thereof that provide an award based on displayed symbols.

2. Description of Related Art

In some conventional gaming machines, symbols displayed on each surface of polyhedral elements of each polyhedron are used. In above gaming machines, payouts are provided based on the combination of the symbols displayed on side face or top face of the polyhedron in addition to symbols displayed on front face of the polyhedron. Accordingly, it is determined whether or not predetermined combination is realized based on the symbols displayed on each surface of polyhedral elements of each polyhedron on paylines. In above gaming machines, it is not determined whether or not predetermined combination is realized based on only symbols displayed on same surface (for example, only front surface) of polyhedral elements of each polyhedron on paylines.

In the above conventional examples, because all combinations of displayed symbols on all surfaces of polyhedral elements are judged, it is difficult to understand all combinations for the player. That is, even though the player wants to enjoy the game, the player may have to think many combinations of the symbols on the many surfaces of polyhedral elements.

### SUMMARY

In view of the foregoing, one or more aspects of the present invention relate to a gaming machine, a gaming method thereof, a computer readable medium having computer-executable instructions or the like that have plural polyhedrons. Also, in one or more aspects of the present invention, each of the reels may be constructed from the polyhedrons. Each of the reels may be spun and then stopped and displayed. Each of the polyhedrons may be rotated longitudinally or laterally, and then stopped and displayed. An award may be provided based on symbols displayed on each of the surface of each polyhedron. Also, if a predetermined symbol is displayed on the front surface of the polyhedron, only the polyhedron having the predetermined symbol may be rotated. One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a view showing an image of a lower image display panel in the case of that three video reels are stopped and displayed in accordance with one or more aspects of the present invention.

FIG. 2 is a perspective view showing a slot machine in an illustrative embodiment in accordance with one or more aspects of the present invention.

FIG. 3 is a view schematically showing symbols displayed on each surface of each of cubes forming each video reel in accordance with one or more aspects of the present invention.

FIG. 4 is a block diagram schematically showing a control system of the slot machine in the illustrative embodiment in accordance with one or more aspects of the present invention.

FIG. 5 is a view showing a payout table of the slot machine which indicates winning combinations, probabilities thereof, and payout numbers thereof in the illustrative embodiment in accordance with one or more aspects of the present invention.

FIG. 6 is a view schematically showing the video reel in accordance with one or more aspects of the present invention.

FIG. 7 is a view a condition of that the video reel spins in accordance with one or more aspects of the present invention.

FIG. 8 is a view a condition of that each polyhedron rotates longitudinally in accordance with one or more aspects of the present invention.

FIG. 9 is a view a condition of that each polyhedron rotates laterally in accordance with on or more aspects of the present invention.

FIG. 10 is a view schematically showing three video reels in accordance with one or more aspects of the present invention.

FIG. 11 is a flowchart of a part of a main control process program of the slot machine in the illustrative embodiment in accordance with one or more aspects of the present invention.

FIG. 12 is a flowchart of a part of the main control process program of the slot machine in the illustrative embodiment in accordance with one or more aspects of the present invention.

FIG. 13 is a flowchart of a part of a base game lottery process program of the slot machine in the illustrative embodiment in accordance with one or more aspects of the present invention.

FIG. 14 is a flowchart of a part of a reel control process program of the slot machine in the illustrative embodiment in accordance with one or more aspects of the present invention.

FIG. 15 is a view showing an example of the lower image display panel in which three video reels are spun in a second control process in accordance with one or more aspects of the present invention.

FIG. 16 is a view showing an example of the lower image display panel in which three video reels are spun in the second control process in accordance with one or more aspects of the present invention.

FIG. 17 is a view showing an example of the lower image display panel in which three video reels are spun in the second control process in accordance with one or more aspects of the present invention.

FIG. 18 is a view showing an example of the lower image display panel in which three video reels are spun in the second control process in accordance with one or more aspects of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

An embodiment embodying one or more aspects of the invention as a slot machine will be described in detail with reference to the drawings below. In base games executed in the slot machine of the embodiment, video reels are used. The number of the video reels may be three. The video reel may be constructed from polyhedrons (for example, twelve polyhedrons). Each of the polyhedral may have six faces. Symbols may be displayed on each of the faces. Each of the polyhedrons may form ring shape. First variably display and second variably display may be produced on a lower image display panel in a unit game of the base game. In the first variably display, each of the video reels may be spun. In the second variably display, each of the polyhedrons may be rotated about a virtual center axis. The virtual center axis passes through the side surface. And then, symbols may be arranged on each of the surfaces of each of the polyhedrons. If the combination of the symbols displayed on each of the front surface of the polyhedrons is any winning combination, the payout corresponding thereto may be provided to the player.

If it is determined that “THUNDER” symbol will be temporarily displayed, after the first variably display and the second variably display at same time, the “THUNDER” symbols may be displayed on the lower display panel. Here, in the first variably display, each of the video reels may be spun. In the second variably display, each of the polyhedrons forming the video reels may be rotated about the virtual axis which passes through the side surface thereof. After that, if the player selects any of the “THUNDER” symbols displayed on the front surface of the polyhedrons, only the polyhedrons having the selected surface may be rotated with the second variably display. Herewith, each of the video reels may be stopped and displayed on the lower image display panel.

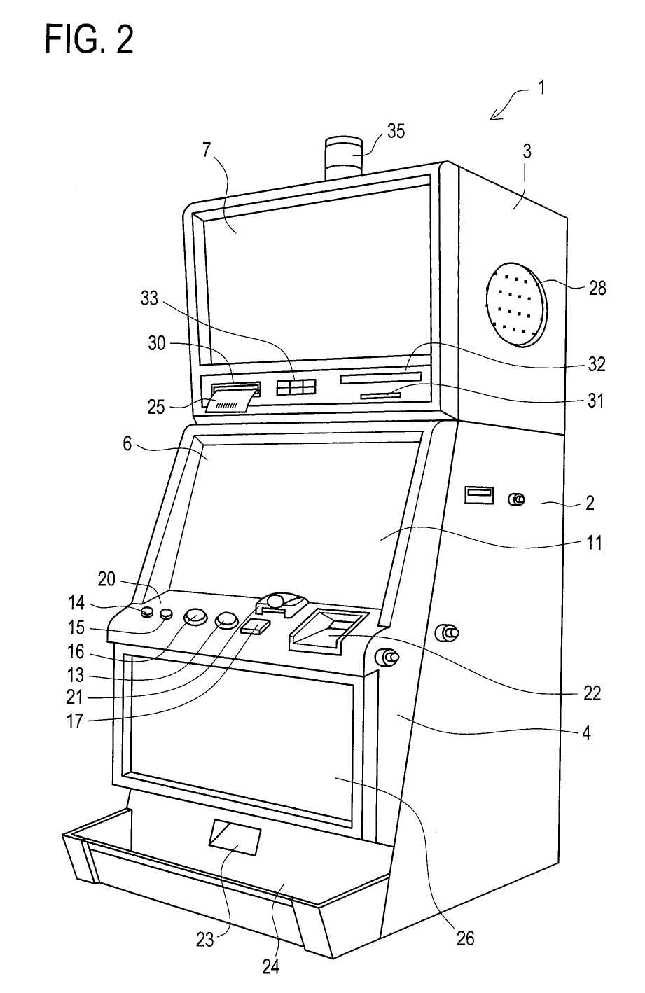

The embodiment embodying one or more aspects of the invention as the slot machine will be described in detail with the reference drawings below. At first, a construction of the slot machine of the embodiment embodying one or more aspects of the invention will be described with reference to FIG. 2. FIG. 2 is a perspective view showing the slot machine of the embodiment.

The slot machine 1 may include a cabinet 2, a top box 3, and a main door 4. The top box 3 is arranged on the cabinet 2 (for instance, arranged on upper side). The main door 4 is arranged at front of the cabinet 2.

An upper image display panel 7 is arranged with the slot machine 1 (for example, arranged in front of the top box 3). The upper image display panel 7 may include the display device (for example, LCD panel). Gaming information such as demonstration image, the game rule, the payout table, or the like may be displayed on the upper image display panel 7.

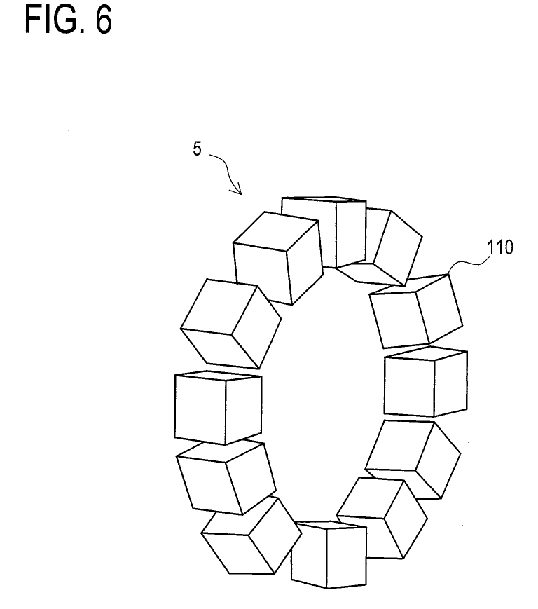

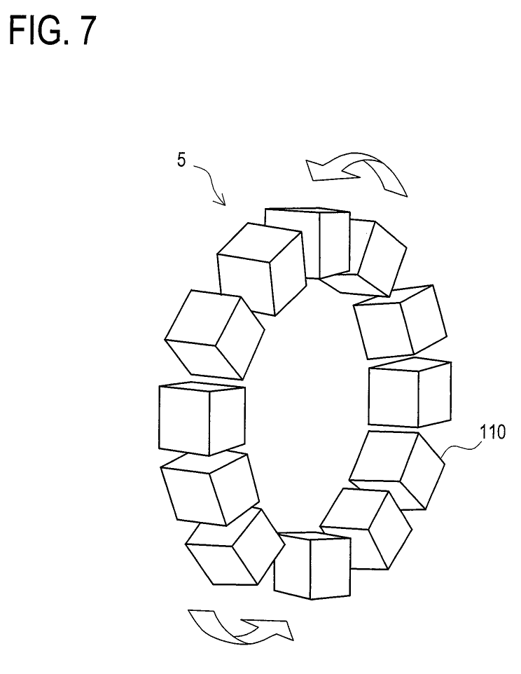

A lower image display panel 6 is arranged with the slot machine 1 (for example, arranged in front of the main door 4). Images of the base game in the slot machine 1 displayed on the lower image display panel 6 will be described. FIG. 6 shows a perspective view showing a video reel 5 displayed on the lower image display panel 6. As shown in FIG. 6, the video reel may be constructed from twelve polyhedrons. The polyhedrons may be spaced uniformly and may form ring shape. The polyhedrons may be cube. Here, the polyhedrons are variable. For example, the polyhedrons may be rectangular prism, octahedron, or the like. Each of the video reels 5 may be spun from the top to the down and stopped on the lower image display panel 6. FIG. 7 is a perspective view showing that the video reel 5 is spun.

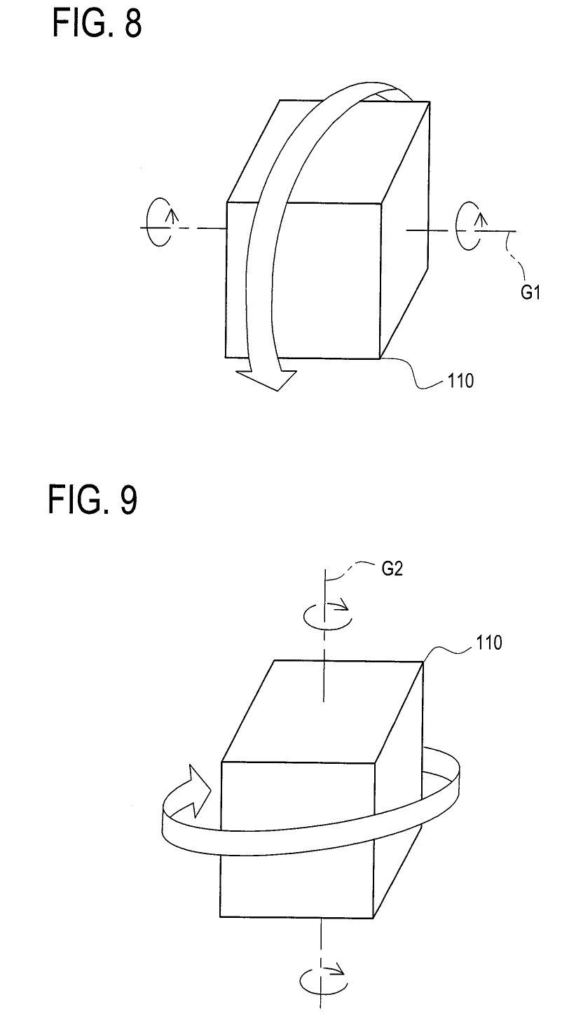

Each of the polyhedrons forming the video reel 5 is rotated longitudinally or laterally, and then stopped and displayed on the lower image display panel 6. FIG. 8 is a perspective view showing that each of the polyhedrons is rotated longitudinally. FIG. 9 is a perspective view showing that each of the polyhedrons is rotated laterally.

Each polyhedron may be rotated longitudinally (for example, from the top to the bottom). As shown in FIG. 8, each polyhedron may be rotated about virtual center line G1. The virtual center line G1 passes through both side surfaces (left side surface and right side surface) of the polyhedron displayed on the lower image display panel 6. The virtual center line G1 and virtual tangent line of video reel 5 intersect at right angle.

Each polyhedron may be rotated laterally (for example, from the right to the left). As shown in FIG. 9, each polyhedron may be rotated about virtual center line G2. The virtual center line G2 passes through both side surfaces (top side surface and bottom side surface) of the polyhedron displayed on the lower image display panel 6. The virtual center line G2 may be part of virtual tangent line of video reel 5 intersect at right angle.

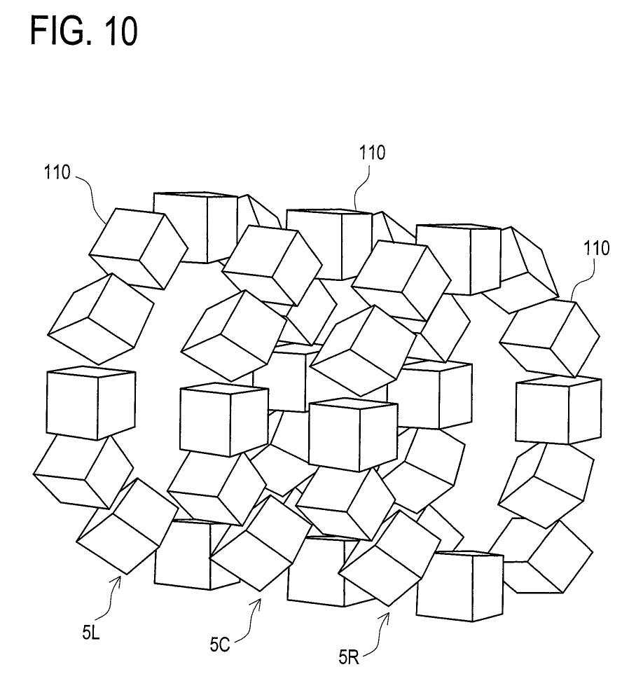

Three video reels may be lines up on the lower image display panel 6. Each of three video reels may be rotated from the top to the bottom. At the same time, each of the polyhedrons may be rotated longitudinally or laterally. FIG. 10 is a perspective view showing that three video reels 5L, 5C, and 5R are rotated.

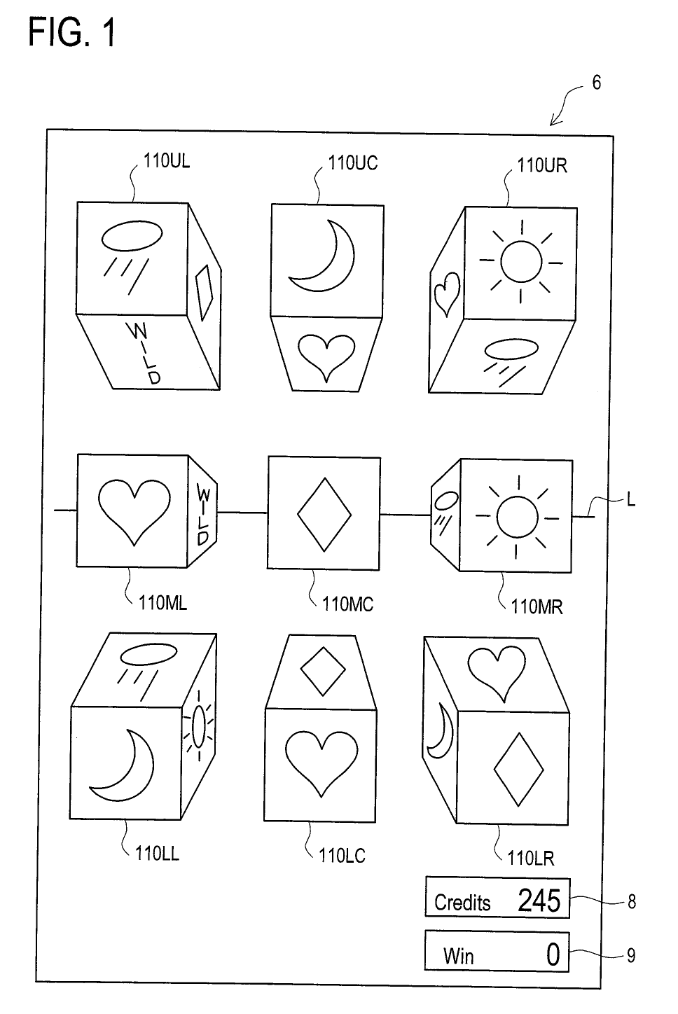

When three spinning video reels are stopped and displayed, each three polyhedrons forming each video reel 5L, 5C, and 5R are displayed on the lower image display panel 6. FIG. 1 shows an example of that three video reels stopped and displayed on the lower image display panel 6.

As shown in FIG. 1, if the three video reels stopped and displayed on the lower image display panel 6, nine polyhedrons 110UL, 110UC, 110UR, 110ML, 110MC, 110MR, 110LL, 110LC, and 110LR are displayed with 3×3 matrix.

In this case, the front surface of each nine polyhedrons 110UL, 110UC, 110UR, 110ML, 110MC, 110MR, 110LL, 110LC, and 110LR may be displayed. Also, the bottom surface of each three polyhedrons 110UL, 110UC, and 110UR (located at top row of the 3×3 matrix) may be also displayed. The right surface of the polyhedron 110UL may be also displayed. The left surface of the polyhedron 110UR may be also displayed. The top surface of each three polyhedrons 110LL, 110LC, and 110LR (located at bottom row of the 3×3 matrix) may be also displayed. The right surface of the polyhedron 110LL may be also displayed. The left surface of the polyhedron 110LR may be also displayed. The right surface of the polyhedron 110ML (located at middle row of the 3×3 matrix) may be also displayed. The left surface of the polyhedron 110MR (located at middle row of the 3×3 matrix) may be also displayed. With respect to the polyhedron 110MC, only front surface may be displayed.

The left video reel 5L (see FIG. 10) may include three polyhedrons 110UL, 110ML, and 110LL which is located left column of the 3×3 matrix. The center video reel 5C (see FIG. 10) may include three polyhedrons 110UC, 110MC, and 110LC which is located center column of the 3×3 matrix. The right video reel 5R (see FIG. 10) may include three polyhedrons 110UR, 110MR, and 110LR which is located right column of the 3×3 matrix.

In this way, in the base game of slot machine 1, three video reels 5L, 5C, and 5R are spun, and then stopped and displayed on the lower image display panel 6. As mentioned above, when three video reels 5L, 5C, and 5R are spun (from the top to the bottom) and displayed, at the same time, each of the polyhedrons forming each video reel 5L, 5C, and 5R is rotated (longitudinally or laterally) and displayed (see FIG. 10).

As mentioned above, each of the video reels 5L, 5C, and 5R (namely, each of the polyhedrons forming the video reels) may be spun (from the top to the bottom) and displayed (hereinafter, “first variably display”). Also, each of the polyhedrons 110 forming each of the video reels 5L, 5C, and 5R are rotated longitudinally or laterally (hereinafter, “second variably display”).

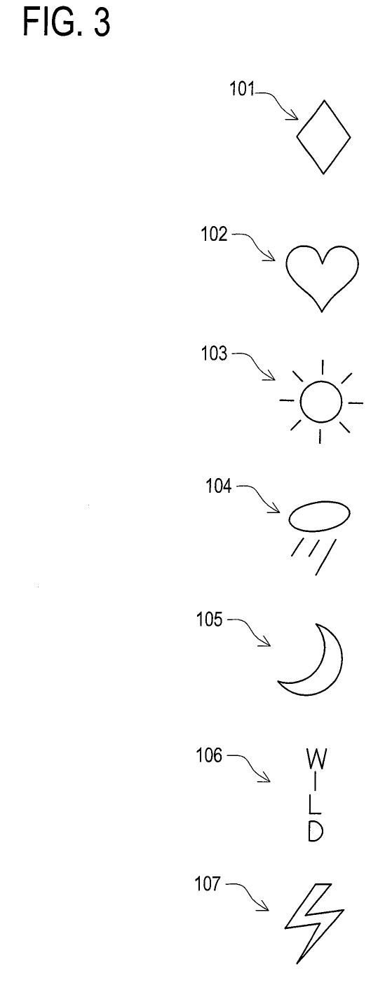

Six symbols (see FIG. 3) are displayed on six surfaces of each polyhedron 110 which is forming three video reels 5L, 5C, and 5R. Here, six symbols are different each other. Also, the number of surface and symbols are variable. A touch panel 11 (see FIG. 2) is arranged at the front of the lower image display panel 6, and the player can input various instructions by operating the touch panel 11.

A credit count display portion 8 and a payout number display portion 9 are arranged on the lower image display panel 6. The credit count in which the player currently owns may be displayed on the credit count display portion 8. The payout number, which indicates the payout number, which will be provided when a combination of stopped and displayed symbols on payline(s) L, is any of predetermined combinations or will be acquired in the bonus game, may be displayed on the payout number display portion 9.

Twenty one symbols (among symbols displayed on each six surfaces of each polyhedron forming each video reel 5L, 5C, and 5R) are arranged on the lower image display panel 6.

As shown in FIG. 1, the payline L may cross three polyhedrons 110ML, 110MC, and 110MR (located at the middle row of the 3×3 matrix). The payline(s) L may set the combination of the symbols. Here, the combination may be constructed from the symbols displayed on the front surface of three polyhedrons 110ML, 110MC, and 110MR (located at the middle row of the 3×3 matrix) on the lower image display panel 6. In the bonus game, each nine polyhedron 110UL, 110UC, 110UR, 110ML, 110MC, 110MR, 110LL, 110LC, and 110LR and the payline are erased, and predetermined bonus image may be displayed in addition to the credit count display portion 8 and the payout number display portion 9.

Returning FIG. 2, a control panel 20 is arranged at the image display panel 6 (for example, arranged on lower side). Buttons are arranged at the control panel 20. The buttons are the buttons to input the instructions for gaming session by the player. A coin insertion slot 9 and a bill verifier 22 can be arranged in relation to the image display panel 6 (for example, arranged on lower side). The coin insertion slot 21 may receive the gaming medium into the cabinet 2. A spin button 13, a change button 14, a cash out button 15, a 1-bet button, and a max-bet button 17 are arranged on the control panel 20. The spin button 13 can be used when the instruction for the start for the reels 5L, 5C, and 5R spin is input. Here, a physical lever may be used as substitute for the spin button 13. Also, the physical lever may be used in conjunction with the spin button 13. The change button 14 is used when the exchange is required. The cash out button 15 is the instruction for the payment of the coin (for example, one credit is equal to one coin) or for the print a ticket 25. One or more bar codes may be printed in the ticket 25. The ticket 25 may be called GAMING VOUCHER. The coin may be paid through a coin payout opening 23 to a coin tray 24. Here, other than bar code may be used as substitute for the bar code (for example, QR Code (two-dimensional bar code)). The 1-bet button 16 is used when the instruction, in which one bet from the player's credits is conducted, is required. The max-bet button 17 is used when the instruction, in which available maximum bet count in one game (for example, fifty credits) from the credits which is owned by the player is conducted, is required.

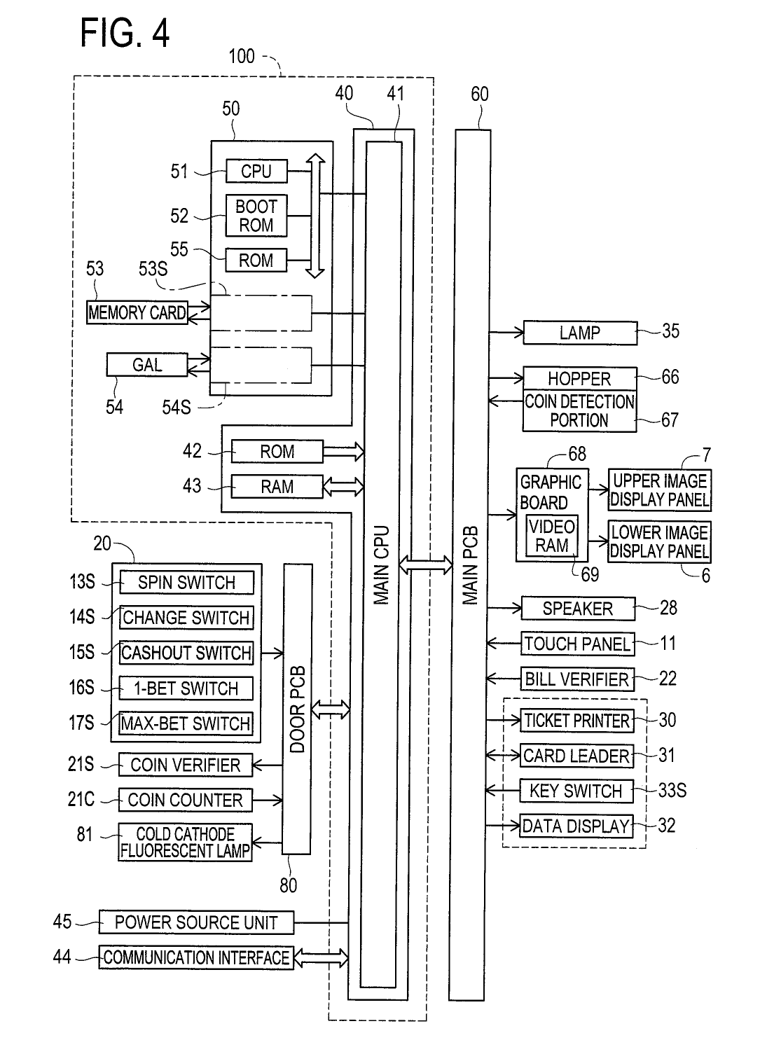

A coin verifier 21S (see FIG. 4) and a coin counter 21C (see FIG. 4) are arranged inside of the coin slot 21. The coin verifier 21S (see FIG. 4) verifies the coin inserted from the coin insertion slot 21, and the fake coins may be discharged through the coin payout opening 23. The coin counter 21C detects qualified coin and counts the number of the coins.

The bill verifier 22 verifies the bill and receives qualified bill into cabinet 2. The bill which is received into cabinet 2 is converted to the coin count, and the credit count corresponding to the converted coin count may be added to the owned credit count of the player. The bill verifier 22 can read a ticket 25 (which will be described later). A panel 26 is arranged on the main door 4 (for example, arranged on lower side, namely arranged below the control panel 20). Characters of the slot machine 1 may be displayed on the panel 26.

In the slot machine of the embodiment, the gaming medium may be coin, bill, or electronic value (credit). Here, the gaming medium may be other things as well (including but not limited to medal, token, electronic money, or ticket).

A ticket printer 30, a card reader 31, a data display 32, and a keypad 33 are arranged at the upper image display panel 7 (for example, arranged on lower side). The ticket printer 30 prints the ticket with the bar code in which the data (such as credit count, date, or ID number of the slot machine 1) may be coded. The printed ticket is the ticket 25. When the ticket 25 is scanned by other gaming machines, the player will be able to play the other gaming machines or be able to go through some procedure in some place. The card reader 31 reads from the storage medium (for example, smart card) and writes the storage medium (for example, smart card). The player owns the storage medium, and the gaming record of the player is stored in the storage medium. The data (which is read by the card reader 31 or input data which is input by the player via the keypad 33) may be displayed on the data display 32. The keypad 33 may be used when the player input the instruction or the data related to the print the ticket (for example). A lamp 35 is arranged at the top box 3 (for example, arranged on top). The lamp 35 may turn on with predetermined pattern when the player wants call the clerk of the game hall when the slot machine 1 has errors (for example). Here, loudspeaker 28 may be arranged.

The symbols will be described with reference to FIG. 3. The symbols are displayed on the surfaces (for example, six surfaces) of each polyhedron which forms each of the video reels 5L, 5C, and 5R. When each of the video reels are spun and stopped on the lower image display panel 6, the symbols may be rearranged. FIG. 3 is a view schematically showing the symbols displayed on each six surfaces of each polyhedron 110 which forms each of the video reels 5L, 5C, and 5R.

The symbols displayed on each surfaces of each polyhedrons will be described. Here, polyhedrons form the left video reel 5L, the center video reel 5C, and the right video reel 5R. The symbols displayed on each surfaces of one polyhedrons are different each other. For example, if the polyhedron has six surfaces, six symbols are displayed and different each other. FIG. 3 shows symbols displayed on the surface of the polyhedron. The symbols may include “DIAMOND” symbol 101, “HEART” symbol 102, “SUN” symbol 103, “RAIN” symbol 104, “MOON” symbol 105, and “WILD” symbol 106. Each symbol is arranged on each of surface of each polyhedron (which forms each video reels 5L, 5C, and 5R) in predetermined order.

Only when it is determined that the “THUNDER” symbols will be displayed on the image display panel 6, the “THUNDER” symbol 107 may be displayed on the front surface of the polyhedrons 110ML, 110MC, or 110MR in place of current symbol in the lower image display 6. The concrete explanation about that will be described later.

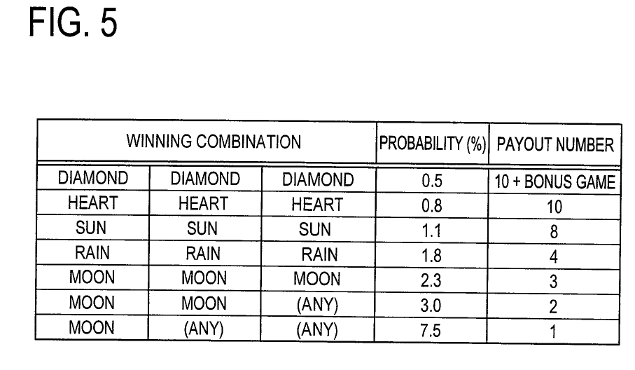

If three same symbols “DIAMOND”, “HEART”, “SUN”, “RAIN”, or “MOON” are arranged and displayed on the front surface of polyhedrons 110ML, 110MC, and 110MR (which are located at middle row of the matrix and on the payline), predetermined payout number will be provided to the player (see FIG. 5).

If two “MOON” symbols are arranged and displayed on the front surface of any two of polyhedrons 110ML, 110MC, and 110MR (which are located at middle row of the matrix and on the payline), predetermined payout number will be provided to the player (see FIG. 5) based on the number (namely, two, see FIG. 5). If one “MOON” symbol is arranged and displayed on the front surface of any two of polyhedrons 110ML, 110MC, and 110MR (which are located at middle row of the matrix and on the payline), predetermined payout number will be provided to the player (see FIG. 5) based on the number (namely, one, see FIG. 5).

On the other hand, if one or two “WILD” symbols are arranged and displayed on the front surface of any two of polyhedrons 110ML, 110MC, and 110MR (which are located at middle row of the matrix and on the payline), the “WIDL” symbols may substitute for any or “DIAMOND”, “HEART”, “SUN”, “RAIN”, or “MOON”. If three “WILD” symbols are arranged and displayed on the front surface of polyhedrons 110ML, 110MC, and 110MR (which are located at middle row of the matrix and on the payline), the payout number will be provided to the player. Here, the payout number of three “WILD” may be the same as the payout number of three “HEART”.

Also, if one, two or three “THUNDER” symbols are arranged and displayed on the front surface of any two of polyhedrons 110ML, 110MC, and 110MR (which are located at middle row of the matrix and on the payline), payout number “1” will be provided to the player.

If three “DIAMOND” symbols are arranged and displayed on the front surface of polyhedrons 110ML, 110MC, and 110MR (which are located at middle row of the matrix and on the payline) on the lower image display panel 6, the predetermined payout number will be provided to the player, in addition, the procedure will be the bonus game. Here, the game executed in the slot machine 1 of the embodiment may include the base game and the bonus game. In the base game, predetermined combination of the symbols may be arranged on the payline with the use of the video reels 5L, 5C, and 5R. On the other hand, in the bonus game, three treasure boxes (selection items) are displayed on the lower image display panel 6, and the payout corresponding to selected treasure boxed by the player will be provided. Here, concrete explanation of the bonus game will be omitted.

Here, twenty one symbols (the part of the symbols displayed on each six surfaces of each polyhedron forming each video reel 5L, 5C, and 5R) are arranged on the lower image display panel 6. When the bet count is determined based on the operation of the 1-bet button 16 or max-bet button 17, and then the spin button 13 is input, the symbols displayed on the each surface of each polyhedron 110 (forming each of the video reels 5L, 5C, and 5R) will start to spin from the top to the bottom.

After a predetermined time is elapsed, the video reels 5L, 5C, and 5R will end spinning. Accordingly, twenty one symbols (the part of the symbols displayed on each six surfaces of each polyhedron forming each video reel 5L, 5C, and 5R) are arranged on the lower image display panel 6 (see FIG. 1).

Here, winning combinations may be set beforehand (see FIG. 5). If the combination of the symbols displayed on the payline is any of the winning combinations, the payout number corresponding to realized combination will be provided to the player.

Also, if one, two, or three “THUNDER” symbols are rearranged on the payline L, the payout number “1” may be provided to the player. Here, the combination may be constructed of the symbols arranged on the front surface of the polyhedrons 110ML, 110MC, and 110MR (which are located at middle row of the matrix and on the payline). Concretely, as shown in FIG. 1, the combination may be constructed from “HERAT” symbol on the front surface of the polyhedron 110ML, “DIAMOND” symbol on the front surface of the polyhedron 110MC, and “SUN” symbol on the front surface of the polyhedron 110MR.

The spin and stop for the video reels 5L, 5C, and 5R may include the first variably display (namely, each of the video reels 5L, 5C, and 5R (each of the polyhedrons 110 forming the video reels) are rotated from the top and to the bottom and stopped) and the second variably display (namely, each of the polyhedrons 110 forming the video reels rotated longitudinally or laterally). The first variably display and the second variably display may be produced at one time. Accordingly, the symbols arranged on the payline may be determined.

Here, if the “THUNDER” symbol is displayed on any of the front surface of the polyhedrons 110ML, 110MC, and 110MR (which are located at middle row of the matrix and on the payline), only the polyhedron (any of the polyhedrons 110ML, 110MC, or 110MR) having the front surface selected by the player via the touch panel may be rotated longitudinally or laterally with the second variably display. Herewith, the symbols may be rearranged on the payline L.

A control system of the embodiment of the slot machine 1 will be described with reference to FIG. 4. FIG. 4 is block diagram schematically showing the control system of the slot machine 1 of the embodiment.

The control system of the slot machine 1 may be constructed from a mother board 40 and a gaming board 50 as shown in FIG. 4. The gaming board 50 may be constructed from a CPU 51, a ROM 55, a boot ROM 52, a card slot 53S, and an IC socket 54S. The CPU 51, the ROM 55, the boot ROM 52 are interconnected via internal bus. A card slot 53S is adapted to receive the memory card 53. An IC socket 54S is adapted to receive a GAL (Generic Array Logic) 54. Here, PLD (Programmable Logic Device) which is other than the GAL 54 may be substituted for the GAL 54.

The memory card 53 may be constructed from non-volatile memory. Game programs and game system programs (hereinafter, “the game program and the like”) may be stored therein. The game programs stored in the memory card may include lottery program. The lottery program may be used so as to determine symbols (namely, code numbers corresponding to symbols) to be displayed on each of the front surface of the each polyhedron 110ML, 110MC, and 110MR (located at the middle row of the 3×3 matrix), and to be arranged on the payline on the lower image display panel 6. The symbol lottery program may include three symbol weighting data table. Each of the weighting data tables corresponds to each plural payout ratios (for example, 80%, 84%, and 88%). The symbol weighting data table may indicate a relation between each of the code numbers for each symbol of the each surface of each polyhedron (forming three video reels 5L, 5C, and 5R) and predetermined range of the random number values. Each of the code numbers for each symbol of each surface of each polyhedron corresponds to one or more random number values. Accordingly, if random number is sampled, the symbol corresponding to sampled random number value may be arranged on the payline. Here, the payout ratio may be set based on the payout ratio setting data from the GAL 54. Various lotteries may be conducted based on the symbol weighting data corresponding to the payout ratio.

The card slot 53S may be constructed so that the memory card 53 is detachable, and connected to the mother board 40 via bus (for example, IDE bus). The kinds of the game and the contents of the game executed in the slot machine 1 can be changed in a case where the game program and the like stored in the memory card 53. Also, the kinds of games and the contents of the games executed in the slot machine 1 can be changed in a case where the memory card 53 is exchanged to another memory card in which another game program or the like is stored therein. The game program may include the program related to the gaming session, the image data and sound data as output during the gaming session. Also, the game program may include image data of each of the polyhedrons 110 forming the each video reels 5L, 5C, and 5R and the symbol images displayed thereon, the image data such as game rules and payout table, and image data for demonstration.

The GAL 54 can be one of the PLD, which may contains a fixed OR array. The GAL 54 has plural input ports and output ports. If predetermined data is input to the input port(s), the data corresponding thereto will output to the output port(s). The output data is the payout ratio setting data.

The IC socket 54S is constructed so that the GAL 54 is detachable, and connected to the mother board 40 via a bus (for example, PCI bus). The payout ratio setting data can be changed in a case where the GAL 54 is re-written or is exchanged.

The CPU 51, the ROM 55, and the ROM 52 are connected to the mother board 40 via the PCI bus. The CPU 51, the ROM 55, and the boot ROM 52 are interconnected via internal bus. The PCI bus transmits the signal between the mother board 40 and the gaming board 50. The mother board 40 supplies the electric power to the gaming board 50. The country ID and the verification program are stored in the ROM 55. The preliminary verification program and the boot code may be stored in the boot ROM 52. The CPU 51 may boot the preliminary verification program with the use of the boot code.

The verification read program is used to verify the game program and the like. The verification program is executed to check whether or not falsification of data has been done. The verification program checks for the falsification of the game program and the like. The game program and the like will be the object of the verification read process. A preliminary verification program may or may not be used to verify the verification program. The preliminary verification program is written along the procedure for the check of falsification of the verification program. The verification program can be the subject of the verification process.

The mother board 40 will be described. The mother board 40 may be constructed from general mother board (printed circuit board which mounts basic components), and may include a main CPU 41, a ROM 42, a RAM 43, and a communication interface 44.

The ROM 42 may be constructed from a memory device such as the flash memory (for example). The preliminary data such as BIOS program and the payout table in the base game and the bonus game (see FIG. 5) may be stored in the ROM 42. BIOS program can be executed by the main CPU 41. If the BIOS is executed by the main CPU 41, the initial process for predetermined peripheral devices, and the read process for the game program and the like stored in the memory card 53 will be started via the gaming board 50.

The data and the program, which are used when the main CPU 41 runs, are stored in the RAM 43. The verification program (which will be read via the gaming board 50), various programs (such as the game program and the like), the number of the player's credits, and the number of executed games may be stored in the RAM 43.

The communication interface 44 can be a communication device communicating to the server located in the game hall via a communication line or other communication pathway. The slot machine 1 may communicate bet information in the main game process (which will be described later, see S3 of FIG. 14) and/or the random result of a base winning combination lottery process with the server via the communication interface.

A main PCB (Printed Circuit Board) 60 and a door PCB 80 (which will be described later) are connected to the mother board 40 respectively via USB (for example). A power source unit 45 is connected to the mother board 40. If the power source unit 45 supplies the electric power to the mother board 40, the main CPU 41 on the mother board 40 will be booted up. When the electric power is supplied to the gaming board 50, the CPU 51 will be booted up.

A game controller 100 may be constructed from the mother board 40 and the gaming board 50.

Some devices, which generate the input signal to the game controller 100, are connected to the main PCB 60 and the door PCB 80. Some devices, which are control by the control signal from the game controller 100, are connected to the main PCB 60 and the door PCB 80. The game controller 100 executes the game program and the like stored in the RAM 43 based on the input signal which is input thereto. The game controller 100 stores the calculation result to the RAM 43 and controls some devices by executing predetermined calculation process.

The lamp 35, a sub CPU 61, a hopper 66, a coin detection portion 67, a graphic board 68, the loudspeaker 28 (see FIG. 2), a touch panel 11, the bill verifier 22, the ticket printer 30, the card reader 31, a key switch 33, and data display 32 may be connected directly or indirectly to the main PCB 60.

The touch panel 11 may be arranged in front of the lower image display panel 6. The touch panel 11 can recognize the place where the player touches the touch panel 11 based on the coordinate information of the portion touched by the player. Also, the touch panel 11 can recognize the direction where the player touches and moves based on the coordinate information of the portion touched by the player.

The hopper 66 is arranged inside of the cabinet 2. The hopper 66 pays a payout with coins through the coin payout opening 23 to the coin tray 24 based on the control signal from the game controller 100. The coin detection portion 67 is arranged inside of the coin payout opening 23. If the coin detection detects that predetermined coins are paid through the coin payout opening 23, the coin detection portion will output the signal to the game controller 100.

The graphic board 68 controls the display image on the upper image display panel 27 and the lower image display panel 6 based on the control signal from the game controller 100. The player's credit count, stored in the RAM 43, may be displayed of the credit count display portion 8. The payout number may be displayed on the payout count display portions 9. The graphic board 68 may include VDP (Video Display Processor) and a video RAM. The image data generated by the VDP is temporarily stored in the video RAM. The VDP generates the image data based on the control signal from the game controller 100. The data used when the image data is generated by the VDP may be included in the game program. The graphic board 68 controls so that video reels 5L, 5C, and 5R are spun and displayed on the lower image display panel 6 (see FIG. 1, FIG. 14 to 16) based on the control signal form the game controller 100.

The bill verifier 22 verifies the bill or the ticket 25. The bill verifier 22 receives the qualified bill or the ticket 25 into the cabinet 2. When qualified bill is inserted, the bill verifier 22 will output the signal to the game controller 100 based on the value thereof. When qualified ticket 25 is inserted, the bill verifier 22 will output to the game controller 100 based on the number of coins printed thereon.

The ticket printer 30 prints the ticket with the bar code in which the data such as credit count stored in the RAM 43 based on the control signal from the game controller 100. The printed ticket is the ticket 25. The card reader 31 reads from the storage medium (for example, smart card) and transmits the data, which is received by the game controller 100. The card reader writes the storage medium (for example, smart card) based on the control signal from the game controller 100. A keypad 33 is arranged on the key switch 33S. If the keypad 33 is operated by the player, the predetermined input signal will be output to the game controller 100. The data read by the card reader 31 or the data input by the player via the keypad 33 may be displayed on the data display 32 based on the control signal from the game controller 100.

A control panel 22, the coin verifier 21S, and the coin counter 21C are directly or indirectly connected to the door PCB 80. Here, a cold cathode fluorescent lamp 81 may be connected to the door PCB 80. A spin switch 13S, a change switch 14S, a cash-out switch 15S, a 1-bet switch 16S, and a max-bet switch 17S are arranged on the control panel 20. The spin switch 13S is associated with the spin button 13. The change switch 14S is associated with the change button 14. The cash-out switch 15S is associated with the cash-out button 15. The 1-bet switch 16S is associated with the 1-bet button 16. The max-bet switch 17S is associated with the max-bet button 17. Each of switches may output the input signal to the game controller 100 when the button corresponding thereof is operated by the player.

The coin counter 21C is arranged inside of the coin insertion slot 21. The coin counter 21C verifies the coin inserted from the coin insertion slot 21 by the player. Any fake coins may be discharged through the coin payout opening 23. If a qualified coin is detected, the coin counter 21C will output the signal to the game controller 100.

The coin verifier 21S is controlled based on the control signal from the game controller 100. The coin verifier 21S sorts the qualified coins into a cash box (not shown) or the hopper 66. The cash box is arranged inside of the slot machine 1. Here, the lower image display panel 6 is a LED. A cold cathode fluorescent lamp 81 may be arranged back side of the lower image display panel 6 and the upper image display panel 27. Here, a cold cathode fluorescent lamp 81 functions as a back light and turns on based on the control signal from the game controller 100.

The winning combination and payout thereof, in the base game and the bonus game using the reels 5L, 5C, and 5R in the slot machine 1 of the embodiment, will be described with reference to FIG. 5. FIG. 5 shows the payout table which indicates the winning combination, the probability thereof, and the payout number thereof, in the game using the reels 5L, 5C, and 5R. FIG. 5 indicates the payout number in the case where the bet count is “1”. If the bet count is “1”, the payout number shown in FIG. 5 will be added to the credit count. If the bet count is more than “1”, the payout number shown in FIG. 5 will be multiplied by the bet count, and multiplied number will be added to the credit count.

FIG. 5 shows winning probabilities for each of the winning combination with 88% payout ratio in other than the bonus game. The winning probabilities shown in FIG. 5 indicate the probabilities in which each of winning combinations is realized when each of the code numbers corresponding to symbols of each polyhedron 100 forming each of the video reels 5L, 5C, and 5R is determined based on three random number values with the use of the symbol weighing data table. That is, each of the winning combinations does not corresponding random number value.

For example, the winning probability for the bonus game trigger may be 0.5%. If the bonus trigger is realized, three “DIAMIND” symbols will be displayed on each of the front surface of each polyhedron 110ML, 110MC, and 110MR (located at the middle row of the 3×3 matrix) on the lower image display panel 6, and will be rearranged on the payline L, and then the payout number “10” will be provided, in addition, the bonus game will be occurred.

The winning probability for “HEART” may be 0.8%. If the winning combination “HEART” is realized, three “HEART” symbols will be displayed on each of the front surface of each polyhedron 110ML, 110MC, and 110MR (located at the middle row of the 3×3 matrix) on the lower image display panel 6, and will be rearranged on the payline L, and then the payout number “10” per one bet will be provided, in addition, the bonus game will be occurred. The winning probability for “SUN” may be 1.1%. If the winning combination “SUN” is realized, three “SUN” symbols will be displayed on each of the front surface of each polyhedron 110ML, 110MC, and 110MR (located at the middle row of the 3×3 matrix) on the lower image display panel 6, and will be rearranged on the payline L, and then the payout number “8” per one bet will be provided, in addition, the bonus game will be occurred. In the same way mentioned above, each of the relations between the winning probability and the payout number respectively corresponds to each of the winning combinations shown in FIG. 5. Here, the combination not associated with any of the winning combinations shown in FIG. 6 is realized although “WILD” (which can substitute for any or “DIAMOND”, “HEART”, “SUN”, “RAIN”, or “MOON”.) is considered, the game is lost. If the game is lost, none of the payout number will be provided

On the other hand, not shown in FIG. 5, if one, two, or three “THUNDER” symbols are displayed on the polyhedrons 110ML, 110MC, and 110MR (located at the middle row of the 3×3 matrix), the payout number “1” will be provided regardless of the position of the “THUNDER” symbol.

Also, the relation between the winning probability and the payout number may be variable. If three “WILD” symbols are displayed on each of the front surface of each polyhedron 110ML, 110MC, and 110MR (located at the middle row of the 3×3 matrix) on the lower image display panel 6, and will be rearranged on the payline L, the payout number “10” will be provided the same as the payout number of three “HEART”.

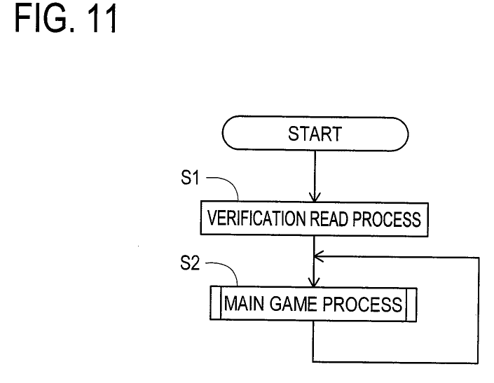

A main control program, which is executed in the slot machine 1 of the embodiment, will be described in detail with reference to the drawing. FIG. 11 is a flowchart of the main control program. Concerning the slot machine 1, the memory card 53 is connected to the card slot 53S of the gaming board 50, and the GAL 54 is connected to the IC socket 54S.

When the power switch of the power source unit 45 is ON, the game controller 100 are booted-up, and the verification read process (S1) is executed. Here, the game controller 100 may be constructed form the mother board 40 and the gaming board 50. In the verification read process, the mother board 40 and the gaming board 50 execute separate processes in parallel. In the gaming board 50, the CPU 51 reads the preliminary verification program from the boot ROM 52, and verifies that the verification program is not falsified before the verification program is taken to the mother board 40. In the mother board 40, the main CPU 41 executes BIOS stored in the ROM 42, and checks and initializes various peripheral devices. Here, BIOS may be compressed, then, BIOS is decompressed. BIOS may be copied to the RAM 43.

The game controller 100 reads the verification program stored in the ROM 55, and verifies that game program and the like are not falsified. Here, the game program and the like is stored in the memory card 53 which is inserted to the card slot 53S. After the verification process is ended, the game controller 100 writes program to the RAM 43, and acquires payout data and country ID. After the process mentioned above is finished, the game controller 100 finishes the verification read process.

In S2, the game controller 100 reads the game program and the like which was verified in S1 from the RAM 43, and executes the main game process. The game in the embodiment of the slot machine 1 is executed by executing the main game process. The main game process is executed repeatedly during the electronic power source is supplied.

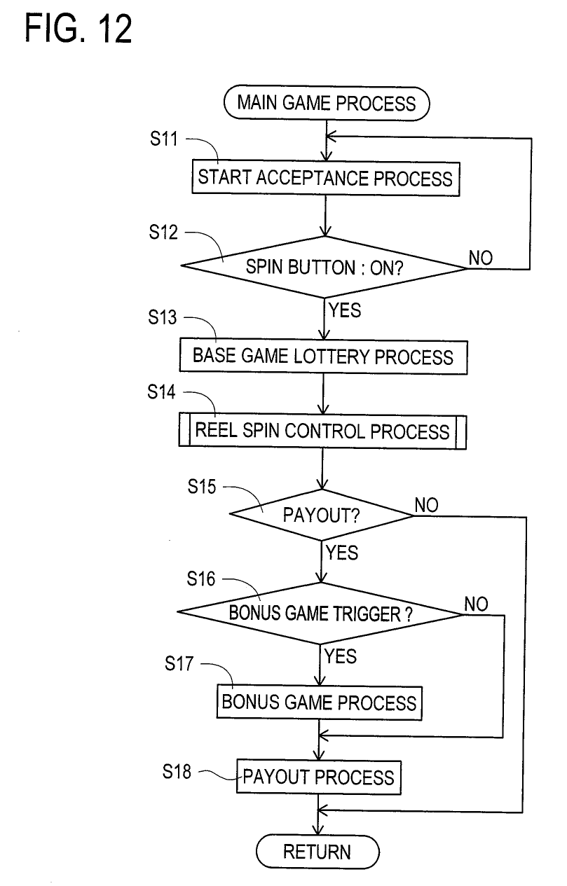

A sub process of the main game process in S2 will be described with reference to FIG. 12. FIG. 12 is a flowchart of the main game process in the embodiment of the slot machine 1. Here, each of the programs shown in the flowcharts in FIG. 12 is stored in the memory card 53. The programs are decompressed to the RAM 43, and decompressed programs are executed by the game controller 100.

In S11, the game controller 100 performs predetermined initial setting, and then, executes the start acceptance process as shown in FIG. 12. The coin is inserted and the bet count for the payline is set during the start acceptance process. The coin is inserted by the player, or the bet operation with the use of the 1-bet button 16 or max-bet button 17 is operated by the player.

In S12, the game controller 100 determines whether or not the spin button 13 is operated. It is determined whether or not the spin button 13 is operated based on that whether or not the input signal is received. If the spin button 13 is not operated (S12:NO), the procedure will be returned to the start acceptance process (S11) again. In that time, some instructions such as to change the bet count are available. On the other hand, if the spin button 17 is operated (S12:YES), the bet count, which is set for the payline L based on the operation of 1-bet button 16 or max-bet button 17, will be subtract from credit count in which the player owns. And, the bet count will be stored in RAM 43 as the bet information.

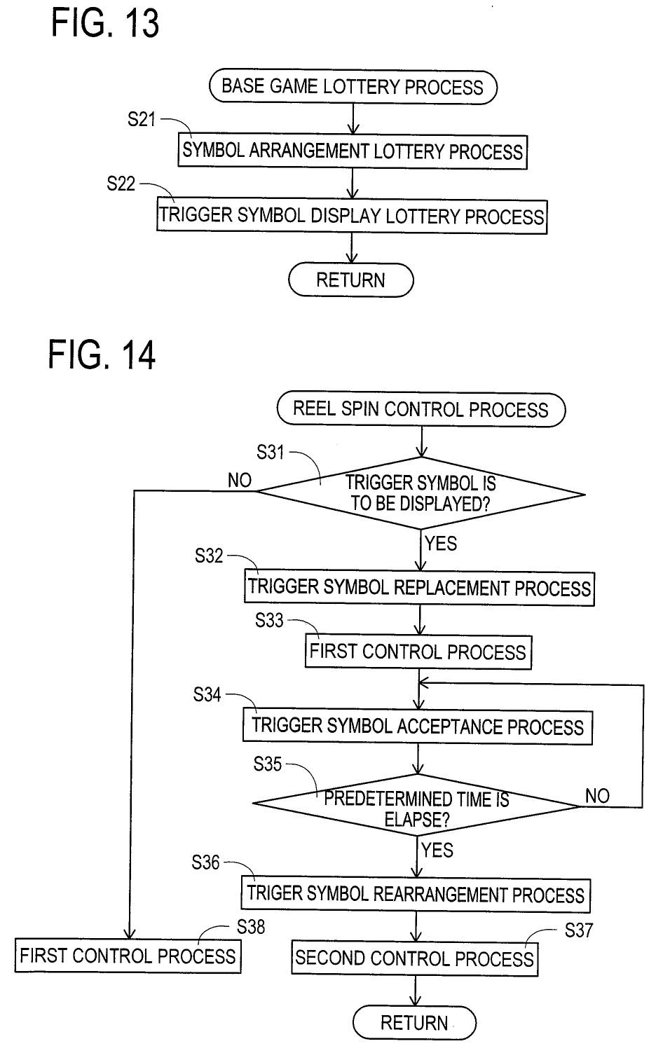

Beginning in S13, the game controller 100 executes the base game with the use of the video reels 5L, 5C, and 5R. At first, in S13, the game controller 100 executes the base game process. A sub process of the base game lottery process of S13 will be described with reference to FIG. 13. FIG. 13 shows a flowchart of the base game lottery process. The programs which are executed as methods of the flowchart shown in FIG. 13 may be stored in the ROM 42 and the RAM 43 in the slot machine 1, and may be executed by the game controller 100.

At first, in S13, the game controller 100 executes a symbol arrangement lottery process. Concretely, the game controller 100 executes random number value generation program included in lottery program stored in the RAM 43, at result, each of the random number values of each reel 5L, 5C, and 5R is generated from the predetermined range of the random number value (“0” to “255”, for example). The code numbers of each symbol of each polyhedron 100 forming each of the video reels 5L, 5C, and 5R may be determined based on three random number values and the symbol weighting table. Each of the symbol weighting tables corresponds to the payout ratio setting data. The procedure will be shifted to S22 after the code numbers of each symbol of each polyhedron 100 forming each of the video reels 5L, 5C, and 5R are stored in the RAM 43.

Here, each of the code number of each symbols of each polyhedron forming each of the video reels 5L, 5C, and 5R corresponds to each of the code numbers of symbols to be rearranged on the payline. Accordingly, the game controller 100 determines the combination of symbols in current game by determining each of the code numbers of each symbols of each polyhedron forming each of the video reels 5L, 5C, and 5R

In S22, the game controller 100 trigger symbol display lottery process. Concretely, at first, the game controller 100 executes random number value generation program included in lottery program stored in the RAM 43, at result, one random number is sampled from the predetermined range of the random number value (“0” to “255”, for example). And then, it is determined whether or not the “THUNDER” symbol as the trigger symbol will be displayed. The result related to the display may be stored in the RAM 43. If it is determined that the “THUNDER” symbol will be displayed, the game controller 100 will execute random number value generation program included in lottery program stored in the RAM 43, and then, each of the random number values of each reel 5L, 5C, and 5R is generated from the predetermined range of the random number value (“0” to “255”, for example). The position where the “THUNDER” symbol as the trigger symbol will be displayed among the any of the surface of the polyhedrons 110ML, 110MC, or 110MR. The number of the position is from “1” to “3”. And then, information related to the position will be stored in the RAM 43. The procedure will be shifted to the main game process of FIG. 12.

When the procedure is shifted to the main game process of FIG. 12 as mentioned above, in S14, the game controller 100 executes the reel spin control process. A sub process of the reel spin control process of S14 will be described with reference to FIG. 14. FIG. 14 shows a flowchart of the reel spin control process executed in the slot machine 1 of the embodiment. The programs which are executed as methods of the flowchart shown in FIG. 13 may be stored in the ROM 42 and the RAM 43 in the slot machine 1, and may be executed by the game controller 100.

At first, as shown in FIG. 14, in S31, the game controller 100 determined whether or not the trigger symbol will be displayed. In the determination, the result related to the display stored in the RAM 43 will be used. If it is determined that the trigger symbol is not to be displayed (S31:NO), the procedure will be shifted to S38.

In S38, the game controller 100 executes the first control process. The first control process is executed in the game controller 100 and the graphic board 68. In the first control process, the first variably display and the second variably display may be produced at one time. In the first variably display, each of the video reels 5L, 5C, and 5R (each of the polyhedrons 110 forming the video reels) are rotated from the top and to the bottom and stopped. In the second variably display, each of the polyhedrons 110 forming the video reels rotated longitudinally or laterally. For the sake of the stop for all video reels 5L, 5C, and 5R, the symbols determined in the base game lottery process (S13) is displayed on the surface of the each polyhedron 110ML, 110MC, and 110MR on the payline (located at the middle row of the 3×3 matrix), namely the combination of the symbols determined in the symbol arrangement lottery process (S21) of the base game lottery process (S13) may be arranged on the payline. After that, the procedure will be returned to the main game process of FIG. 12 as mentioned above.

On the other hand, in S31, if it is determined that the trigger symbol will be displayed (S31:NO), the procedure will be shifted to S32.

In S32, the game controller 100 executes the trigger symbol replacement process. The trigger symbols replacement process will be executed in the game controller 100 and the graphic board 68. In the trigger symbol replacement process, the instruction signal which instructs, that the symbols to be displayed on the position (any of the front surface of the polyhedrons 110ML, 110MC, or 110MR on the middle row of the 3×3 matrix on the payline L) determined in the trigger symbol display lottery process (S22) of the base game lottery process (S13) is replaced with the “THUNDER” symbol, will be sent to the graphic board 68 by the game controller 100.

In S33, the game controller 100 executes the first control process. The first control process is executed in the game controller 100 and the graphic board 68. In the first control process, the first variably display and the second variably display may be produced at one time. In the first variably display, each of the video reels 5L, 5C, and 5R (each of the polyhedrons 110 forming the video reels) are rotated from the top and to the bottom and stopped. In the second display, each of the polyhedrons 110 forming the video reels rotated longitudinally or laterally. For the sake of the stop for all video reels 5L, 5C, and 5R, the symbols determined in the symbol arrangement lottery process (S21) of the base game lottery process (S13) is displayed on the surface of the each polyhedron 110ML, 110MC, and 110MR on the payline (located at the middle row of the 3×3 matrix), namely the combination of the symbols determined in the symbol arrangement lottery process (S21) of the base game lottery process (S13) is arranged on the payline.

Here, as mentioned above, the “THUNDER” symbol may be displayed on the position (any of the front surfaces of the polyhedrons 110ML, 110MC, or 110MR on the middle row of the 3×3 matrix on the payline L) determined in the trigger symbol display lottery process (S22) of the base game lottery process (S13) based on the instruction signal of the S32.

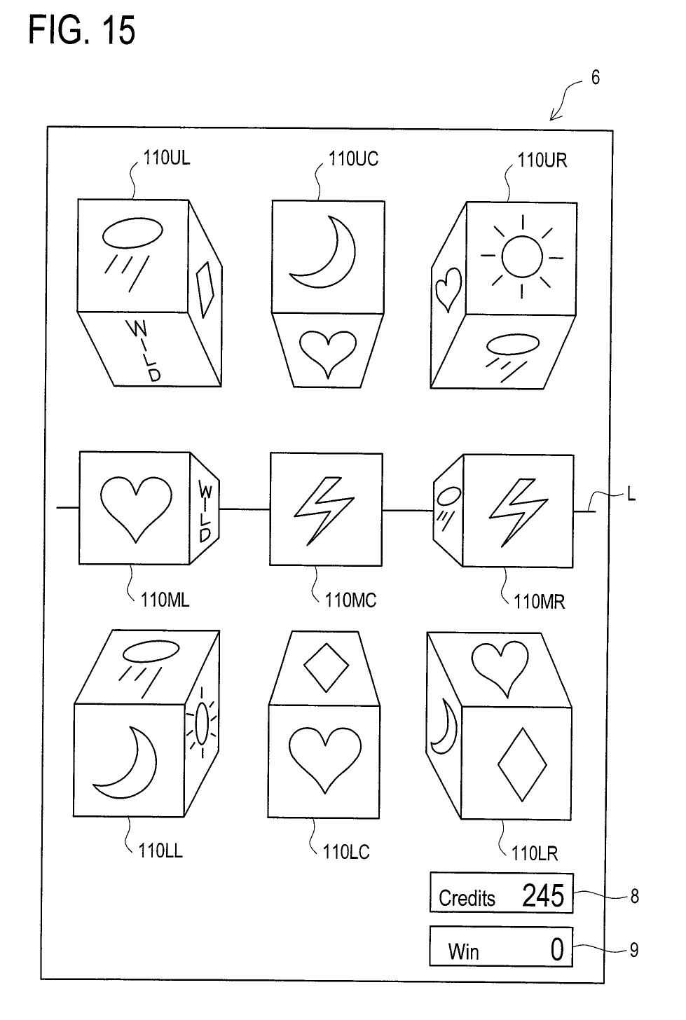

FIG. 15 shows an example of the image of the lower image display panel 6 displaying that the video reels 5L, 5C, and 5R are spun and stopped in the first control process (S33). In FIG. 15, the “THUNDER” symbols are displayed on the front surface of the polyhedrons 110MC and 110MR located on the payline L on the lower image display panel 6.

In S34, the game controller 100 executes the trigger symbol acceptance process. The player can select any of the “THUNDER” symbols displayed on the front surface of the polyhedrons 110ML, 110MC, or 110MR located on the payline L of the lower image display panel 6 via the touch panel 6 in the trigger symbol acceptance process. The information related to the position of the selected polyhedron (among the polyhedrons 110ML, 110MC, or 110MR located in the payline L) will be stored in the RAM 43, and then the procedure will be shifted to S35.

In S35, the game controller 100 determines whether or not predetermined time is elapsed. Here, the predetermined time may be ten second, and the predetermined time is variable. If it is determined that predetermined time is not elapsed (S35:NO), the procedure will be shifted to the trigger symbol acceptance process (S34) again. In this time, selected “THUNDER” symbol may be changed. On the other hand, if it is determined that the predetermined time is elapsed (S35:YES), the procedure will be shifted to S36.

In S36, the game controller 100 executes the trigger symbol rearrangement process. The trigger symbols rearrangement process may be executed in the game controller 100 and the graphic board 68. The instruction signal that cancel the instruction signal of S32 will be sent to the graphic board 68 by the game controller 100. Herewith, the “THUNDER” symbol displayed on the position (any of the front surfaces of the polyhedrons 110ML, 110MC, or 110MR on the middle row of the 3×3 matrix on the payline L) determined in the trigger symbol display lottery process (S22) of the base game lottery process (S13) will be replaced with the symbol determined in the symbol arrangement lottery process (S21) of the base game lottery process (S13) in a second control process which will be described later.

In S37, the game controller 100 executes the second control process. The second control process will be executed in the game controller 100 and the graphic board 68. In the second control process, only polyhedron (any of the polyhedrons 110ML, 110MC, or 110MC located in the middle row of 3×3 matrix on the payline L) having selected “THUNDER” symbol in S34 will be rotated longitudinally or laterally with the second variably display. Herewith, the video reels 5L, 5C, and 5R may be spun and stopped again. For the sake of the stop for all video reels 5L, 5C, and 5R, the symbols determined in the symbol arrangement lottery process (S21) of the base game lottery process (S13) is displayed on the surface of the each polyhedron 110ML, 110MC, and 110MR on the payline (located at the middle row of the 3×3 matrix), namely the combination of the symbols determined in the symbol arrangement lottery process (S21) of the base game lottery process (S13) is arranged on the payline. After that, the procedure will be returned to the main game process of FIG. 12 as mentioned above.

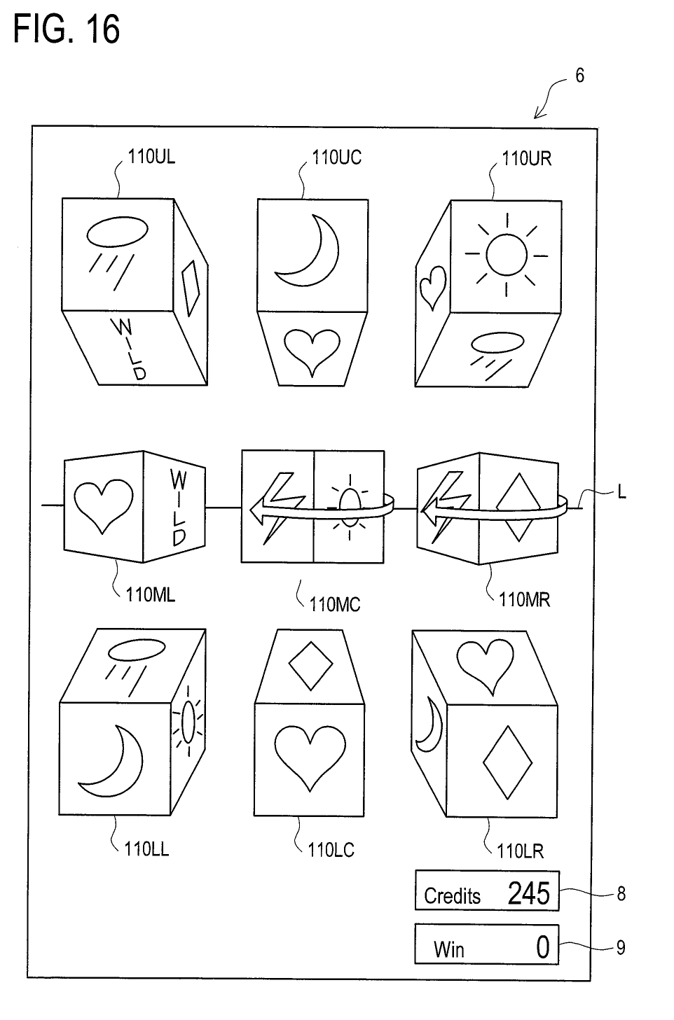

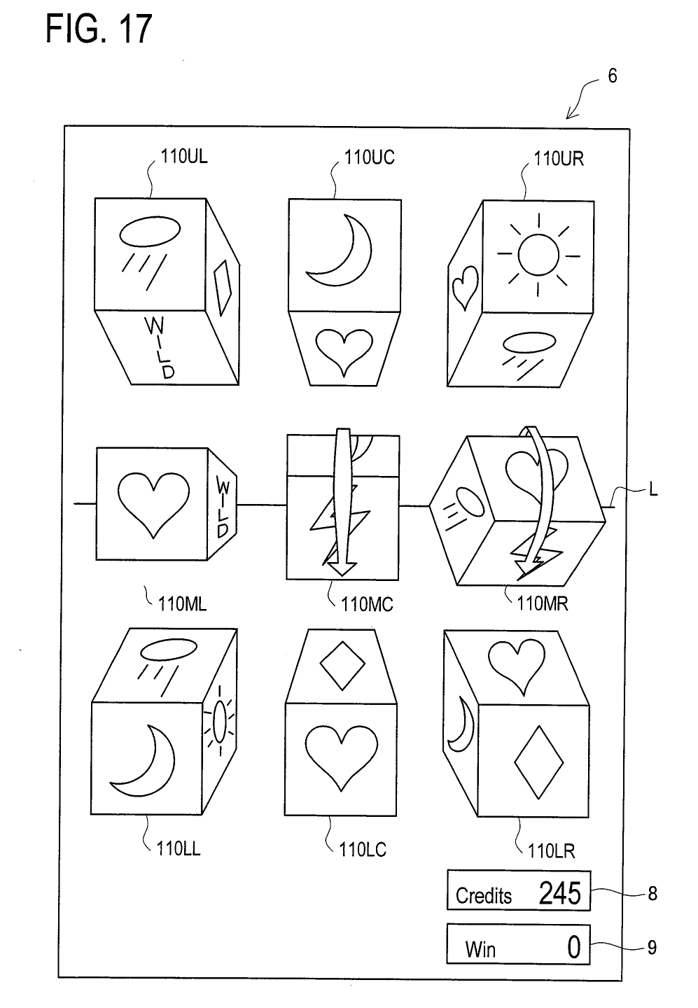

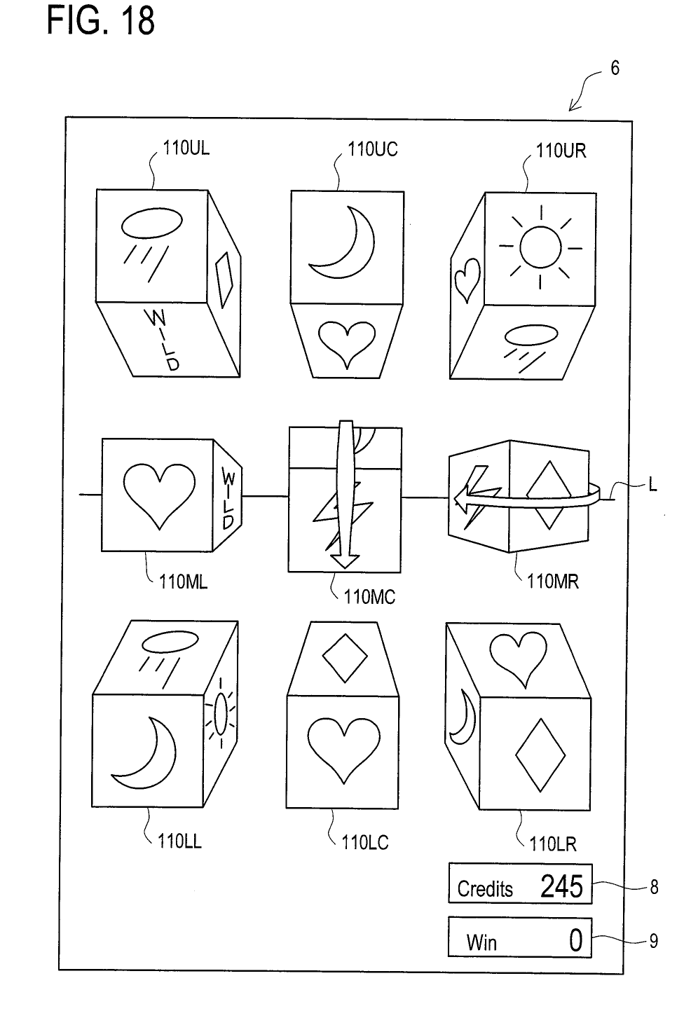

FIG. 16 to FIG. 18 show an example of that three video reels 5L, 5C, and 5R are spun in the second control process (S37). In FIG. 16, two polyhedrons 10MC and 110MR (which are located at middle row of the matrix and on the payline) are rotated laterally. In FIG. 17, three polyhedrons 110MC and 110MR (which are located at middle row of the matrix and on the payline) are rotated longitudinally. In FIG. 18, one polyhedrons 110MR (which is located at middle row of the matrix and on the payline) is rotated laterally, and the polyhedron 110MC is rotated longitudinally.

In FIG. 16 to FIG. 18, in S34, the player may select the “THUNDER” symbol displayed on front surface of the each polyhedron 110ML and 110MC (which are located at middle row of the matrix and on the payline) via the touch panel 11. In S34, if the player selects one “THUNDER” symbol among the symbols displayed on front surface of each polyhedron 110ML and 110MC (which are located at middle row of the matrix and on the payline) via the touch panel 11, only the polyhedron having the surface of the selected “THUNDER” symbol (hereinafter, “selected polyhedron”) by the player will be rotated longitudinally or laterally. On the other hand, in S34 the player selects none of the “THUNDR” symbol, the polyhedrons 110ML, 110MC, and 110MR (which are located at middle row of the matrix and on the payline L) will not be rotated longitudinally or laterally.

Here, in view of relative positional relation of the symbols displayed on each of the surface of each polyhedron 110ML, 110MC, and 110MR (which are located at middle row of the matrix and on the payline), as shown in FIG. 16 and FIG. 17, the probability of the case where three symbols determined in the symbol arrangement lottery process (S21) of the base game lottery process (S13) are arranged on each front surface of the polyhedron 110ML, 110MC, and 110MR (which are located at middle row of the matrix and on the payline) may be low, even though two polyhedrons 100MC and 110MR (which are located at middle row of the matrix and on the payline) are rotated lately. Also, the case where two polyhedrons 100ML and 110MR (which are located at middle row of the matrix and on the payline) are rotated longitudinally may be the same.

Therefore, in the case of that the “THUNDER” symbols are displayed on the front surface of the polyhedrons 110MC and 110MR as shown in FIG. 15, if the player selects all of the polyhedrons 110MC and 110MR displaying the “THUNDER” symbols, the polyhedrons 110MC and 110MR (which are located at middle row of the matrix and on the payline) are rotated longitudinally or laterally during the second control process (S37). Accordingly, the player may be able to enjoy the game more.

A signal system of the first control process (S33 and S38) and the second control process (S37) will be described in detail. At first, the game controller 100 sends the start signal that instructs the video reels start to spin to the graphic board 68. When the graphic board 68 receives the start signal, the graphic board 68 will executes the video reel spin display process. That is, the graphic board 68 controls so that each of the video reels 5L, 5C, and 5R are spun and displayed on the lower image display panel 6.

Here, in the second control process (S37), the game controller 100 sends the information related to the position stored in the RAM 43 in S34 to the graphic board 68. Herewith, the graphic board 68 controls so that only selected polyhedron (any of the polyhedrons 110ML, 110MC, or 110MR) is rotated based on the information related to the position.

After the start signal is sent, the game controller 100 determines a production pattern (for example, the image display on the upper image display panel 7 and output sound from the loudspeaker 28), and the determined production pattern will be conducted. When it becomes predetermined timing in which the video reels 5L, 5C, and 5R are to be stopped, the game controller 100 will transmit the code numbers stored in the RAM 43 to the graphic board 68. The graphic board 68 executes the video reel stop display process based on the code numbers. Accordingly, the symbols corresponding to the random result may be displayed on each of the front surface of each polyhedron 110ML, 110MC, and 110MR (located at the middle row of the 3×3 matrix) on the lower image display panel 6, and will be rearranged on the payline L.

Here, in the first control process (S33), the game controller 100 sends the information related to the position stored in the RAM 43 in S22 to the graphic board 68. Herewith, the graphic board 68 controls so that the “THUNDER” symbols is displayed on selected polyhedron (any of the polyhedrons 110ML, 110MC, or 110MR).

Returning to the main game process of FIG. 12 as mentioned above, in S15, the game controller 100 determines whether or not any winning combination having the payout is realized. If it is determined that any of winning combination (see FIG. 5) is realized (S15:YES), the procedure will be shifted to S23 (which will be described later). On the other hand, none of the winning combination is realized (S15:NO), the main game process will be finished.

In S16, the game controller 100 determines whether or not the bonus trigger is realized in the base game. Concretely, in the case where the payout table shown in FIG. 5 is used, if three “DIAMOND” symbols are displayed on the front surfaces of the polyhedrons 110ML, 110MC, and 110MR (located at the middle row of the 3×3 matrix) on the lower image display panel 6, it is determined that the bonus game trigger is realized.

If it is determined that the bonus trigger is realized (S16:YES), the procedure will be shifted to S17 and then selection-type bonus game process will be executed. Here, the explanation of the bonus game will be omitted. And then, the procedure will be shifted to S18 and then the payout obtained in the base game and the bonus game will be provided to the player. In this time, if the cashout button 15 is pressed, the coin corresponding to the credit count (for example, one credit is equal to one coin) may be paid or the ticket 25 may be printed. After that, the main game process will be executed again.

As mentioned above, in the base game executed in the slot machine 1 of the embodiment, the video reel may be constructed from twelve polyhedrons, the polyhedrons may be spaced uniformly and may form ring shape, the polyhedrons may be cube, and three video reels may be lines up on the lower image display panel 6 (see FIG. 10). The first variably display and the second variably display may be produced on a lower image display panel 6 in a unit game of the base game. In the first variably display, each of the video reels 5L, 5C, and 5R (each polyhedron 110) may be spun. In the second variably display, each of the polyhedrons 110 forming each of the video reels 5L, 5C, and 5R may be rotated longitudinally and laterally. Here, the combination may be constructed from the symbols. If the combination of the symbols is any of the winning combinations (see FIG. 5), the payout corresponding to the winning combination will be provided (S18).

Here, if it is determined that the “THUNDER” symbol will be displayed on the lower image display panel 6 (S22), after first variably display and the second variably display at same time (S33), the “THUNDER” symbol may be displayed on any of the front surface of polyhedrons 110ML, 110MC, or 110MR (S33). In the first variably display, each of the video reels 5L, 5C, and 5R (namely, each of the polyhedrons 110 forming the video reels) may be spun from the top to the bottom. In the second variably display, each of the polyhedrons forming video reels 5L, 5C, and 5R may be rotated longitudinally or laterally. After that, if the player selects any of the “THUNDER” symbols displayed on the front surface of the polyhedrons 110ML, 110MC, or 110MR located at the middle row of the 3×3 matrix (S34), only the polyhedron (among the polyhedrons 110ML, 110MC, or 110MR located at the middle row of 3×3 matrix on the payline L) having selected front surface may be rotated longitudinally or laterally with second variably display (S36). Herewith, the video reels 5L, 5C, and 5R are stopped and symbols are displayed.

Here, aspects of the present invention are not limited to the above embodiment and various changes and modification can be done within the scope of the present invention. For example, if the “THUNDER” symbol is displayed on any of the front surface of the polyhedrons 110ML, 110MC, or 110MR, regardless of the selection of the player via the touch panel 11, when the predetermined time is elapsed, only the polyhedron (among the polyhedrons 110ML, 110MC, and 110MR) having the front surface displaying the “THUNDER” symbol may be rotated longitudinally or laterally with second variably display.

Also, the game controller 100 may control so that the “THUNDER” symbols can be displayed on any of the surfaces of the polyhedrons 110UL, 110UC, 110UR, 110ML, 110MC, 110MR, 110LL, 110LC, or 110LR of the lower image display panel 6. And, in the second control process of S37, only the polyhedron (among the polyhedrons 110UL, 110UC, 110UR, 110ML, 110MC, 110MR, 110LL, 110LC, or 110LR)having the front surface displaying the “THUNDER” symbol may be rotated longitudinally or laterally with second variably display.

In this case, the game controller 100 may control so that the only polyhedron (among the polyhedrons 110UL, 110UC, 110UR, 110ML, 110MC, 110MR, 110LL, 110LC, or 110LR) having the front surface displaying selected “THUNDER” symbol may be executed in the second control process of S37.

Aspects of the present invention may be applied in the field where symbols are displayed on the display device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display configured to display polyhedrons and reels, each of the polyhedrons being constructed from surfaces, each of the surfaces having a symbol, each of the reels being constructed from the polyhedrons with a ring shape, and
a processor programmed to:
(a) variably display and then stop and display each of the reels, and variably display and then stop and display each of the polyhedrons, each of the reels spinning, each of the polyhedrons rotating about an axis, the axis passing the polyhedron,
(b) determine whether a trigger symbol is displayed on any of front surfaces of each of the polyhedrons,
(c) variably display and then stop and display only the polyhedron in response to the trigger symbol being displayed on the front surface of the polyhedron, and
(d) provide an award based on the symbols, each of the symbols being displayed on the front surface of the polyhedron.

2. The gaming machine according to claim 1, further comprising:
a user interface configured to be input by a user,
wherein the processor programmed to:
(a) determined whether the displayed trigger symbol on the front surface of the polyhedron is selected by the user via the user interface, and
(b) variably display and then stop and display only the polyhedron in response to both the trigger symbol being displayed on the front surface of the polyhedron and the trigger symbol being selected.

3. The gaming machine according to claim 1, wherein the processor programmed to determine whether the trigger symbol will be included in the symbols every a unit game, each of the symbols being displayed on the front surface of the polyhedron.

4. A gaming machine comprising:
a display configured to display polyhedrons and reels, each of the polyhedrons being constructed from surfaces, each of the surfaces having a symbol, each of the reels being constructed from the polyhedrons with a ring shape,
a user interface configured to be input by a user, and
a processor programmed to:
(a) determine whether a trigger symbol will be included in the symbols every a unit game, each of the symbols being displayed on a front surface of the polyhedron,
(b) variably display and then stop and display each of the reels, and variably display and then stop and display each of the polyhedrons, each of the reels spinning, each of the polyhedrons rotating about an axis, the axis passing the polyhedron,
(c) determine whether the trigger symbol is displayed on any of front surfaces of each of the polyhedrons,
(d) variably display and then stop and display only the polyhedron in response to both the trigger symbol being displayed on the front surface of the polyhedron and the trigger symbol being selected, and
(e) provide an award based on the symbols, each of the symbols being displayed on a front surface of the polyhedron.

5. A gaming machine comprising:
a display configured to display polyhedrons, reels, and one or more paylines, each of the polyhedrons being constructed from surfaces, each of the surfaces having a symbol, each of the reels being constructed from the polyhedrons with a ring shape, and
a processor programmed to:
(a) variably display and then stop and display each of the reels, and variably display and then stop and display each of the polyhedrons, each of the reels spinning, each of the polyhedrons rotating about an axis, the axis passing the polyhedron,
(b) determine whether a trigger symbol is displayed on any of the front surfaces of each of the polyhedrons on any of the paylines,
(c) variably display and then stop and display only the polyhedron in response to the trigger symbol being displayed on the front surface of the polyhedron on any of the paylines, and
(d) provide an award based on the symbols, each of the symbols being displayed on a front surface of the polyhedron, the polyhedron being on any of the paylines.

6. The gaming machine according to claim 5, further comprising:
a user interface configured to be input by a user,
wherein the processor programmed to:
(a) determined whether the displayed trigger symbols on the front surface of the polyhedron on any of the paylines is selected by the user via the user interface, and
(b) variably display and then stop and display only the polyhedron in response to both the trigger symbol being displayed on the front surface of the polyhedron on any of the paylines and the trigger symbol being selected.

7. The gaming machine according to claim 1, wherein the processor programmed to determine whether the trigger symbol will be included in the symbols every a unit game, each of the symbols being displayed on the front surface of the polyhedron, the polyhedron being on any of the polyhedrons.

8. A gaming machine comprising:
a display configured to display polyhedrons, reels, and one or more paylines, each of the polyhedrons being constructed from surfaces, each of the surfaces having a symbol, each of the reels being constructed from the polyhedrons with a ring shape, and
a processor programmed to:
(a) determine whether a trigger symbol will be included in the symbols every a unit game, each of the symbols being displayed on a front surface of the polyhedron on any of the payline,
(b) variably display and then stop and display each of the reels, and variably display and then stop and display each of the polyhedrons, each of the reels spinning, each of the polyhedrons rotating about an axis, the axis passing the polyhedron,
(c) determine whether a trigger symbol is displayed on any of the front surfaces of each of the polyhedrons on the any of the paylines,
(d) variably display and then stop and display only the polyhedron in response to the trigger symbol being displayed on the front surface of the polyhedron on any of the paylines and the trigger symbol being selected, and
(e) provide an award based on the symbols, each of the symbols being displayed on a front surface of the polyhedron, the polyhedron being on any of the paylines.

9. A gaming method comprising:
(a) variably display and then stop and display reels, and variably display and then stop and display polyhedrons, each of the reels being constructed from the polyhedrons with a ring shape, each of the polyhedrons being constructed from surfaces, each of the surfaces having a symbol, each of the reels spinning, each of the polyhedrons rotating about an axis, and the axis passing the polyhedron,
(b) determine whether a trigger symbol is displayed on any of front surfaces of each of the polyhedrons,
(c) variably display and then stop and display only the polyhedron in response to the trigger symbol being displayed on the front surface of the polyhedron, and
(d) provide an award based on the symbols, each of the symbols being displayed on the front surface of the polyhedron.

10. The gaming method according to claim 9, further comprising:
(a) determined whether the displayed trigger symbol on the front surface of the polyhedron is selected by a user, and
(b) variably display and then stop and display only the polyhedron in response to both the trigger symbol being displayed on the front surface of the polyhedron and the trigger symbol being selected.

11. The gaming method according to claim 9, further comprising:
determine whether the trigger symbol will be included in the symbols every a unit game, each of the symbols being displayed on the front surface of the polyhedron.

12. A gaming method comprising:
(a) determine whether a trigger symbol will be included in symbols every a unit game, each of the symbols being displayed on a front surface of the polyhedron,
(b) variably display and then stop and display reels, and variably display and then stop and display polyhedrons, each of the reels being constructed from the polyhedrons with a ring shape, each of the polyhedrons being constructed from surfaces, each of the surfaces having the symbol, each of the reels spinning, each of the polyhedrons rotating about an axis, the axis passing the polyhedron,
(c) determine whether the trigger symbol is displayed on any of front surfaces of each of the polyhedrons,
(d) variably display and then stop and display only the polyhedron in response to both the trigger symbol being displayed on the front surface of the polyhedron and the trigger symbol being selected, and
(e) provide an award based on the symbols, each of the symbols being displayed on a front surface of the polyhedron.

13. A gaming method comprising:
(a) variably display and then stop and display reels, and variably display and then stop and display polyhedrons, each of the reels being constructed from the polyhedrons with a ring shape, each of the polyhedrons being constructed from surfaces, each of the surfaces having the symbol, each of the reels spinning, each of the polyhedrons rotating about an axis, the axis passing the polyhedron,
(b) determine whether a trigger symbol is displayed on any of the front surfaces of each of the polyhedrons on any of paylines,
(c) variably display and then stop and display only the polyhedron in response to the trigger symbol being displayed on the front surface of the polyhedron on any of the paylines, and
(d) provide an award based on the symbols, each of the symbols being displayed on a front surface of the polyhedron, the polyhedron being on any of the paylines.

14. The gaming method according to claim 13, further comprising:
(a) determined whether the displayed trigger symbols on the front surface of the polyhedron on any of the paylines is selected by the user via the user interface, and
(b) variably display and then stop and display only the polyhedron in response to both the trigger symbol being displayed on the front surface of the polyhedron on any of the paylines and the trigger symbol being selected.

15. The gaming method according to claim 13, further comprising:
determine whether the trigger symbol will be included in the symbols every a unit game, each of the symbols being displayed on the front surface of the polyhedron, the polyhedron being on any of the polyhedrons.

16. A gaming method comprising:
(a) determine whether a trigger symbol will be included in symbols every a unit game, each of the symbols being displayed on a front surface of the polyhedron on any of the payline,
(b) variably display and then stop and display reels, and variably display and then stop and display polyhedrons, each of the reels being constructed from the polyhedrons with a ring shape, each of the polyhedrons being constructed from surfaces, each of the surfaces having the symbol, each of the reels spinning, each of the polyhedrons rotating about an axis, the axis passing the polyhedron,
(c) determine whether the trigger symbol is displayed on any of the front surfaces of each of the polyhedrons on the any of the paylines,
(d) variably display and then stop and display only the polyhedron in response to the trigger symbol being displayed on the front surface of the polyhedron on any of the paylines and the trigger symbol being selected, and
(e) provide an award based on the symbols, each of the symbols being displayed on a front surface of the polyhedron, the polyhedron being on any of the paylines.
